(19) United States
(12) Patent Application Publication
(10) Pub. No.: US 2016/0124614 A1
(43) Pub. Date: May 5, 2016

(54) CONTENT DELIVERY BASED ON REAL-TIME BROWSING ACTIVITY

(71) Applicant: Sidewire, Inc., San Francisco, CA (US)

(72) Inventors: Andy Bromberg, San Francisco, CA (US); Tucker Bounds, San Francisco, CA (US)

(21) Appl. No.: 14/922,765

(22) Filed: Oct. 26, 2015

Related U.S. Application Data
(60) Provisional application No. 62/072,644, filed on Oct. 30, 2014.

(51) Int. Cl. G06F 3/0484; H04L 29/08; G06F 3/0481

(52) U.S. Cl. CPC G06F 3/04842; G06F 3/04817; H04L 67/26; H04L 67/22

(57) ABSTRACT

Example embodiments provide systems and methods to deliver content to consumers based on their real-time internet activity across multiple applications. “Internet activity” encompasses forms of interaction on the internet, including clicking or pressing links, navigating through web pages, navigating or browsing between multiple applications, or loading content via the internet. More specifically, a user is provided with recommended content based on the user's observed internet activity as well as information about the user as specified within user preferences. A notification to access the recommended content is delivered to a device of the user responsive to identifying and retrieving the recommended content, while the user is browsing the Internet in real-time.

### RELATED APPLICATIONS

This application claims the benefit of U.S. Provisional Patent Application No. 62/072,644, filed on Oct. 30, 2014, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2015, SIDEWIRE, All Rights Reserved.

### TECHNICAL FIELD

Embodiments of the present disclosure relate generally to data processing, data analysis, computer technology, content delivery, and more particularly, but not by way of limitation, to a technology platform and user interface for content delivery in real-time.

### BACKGROUND

When accessing content on a mobile device, a user generally selects content to view in one of two ways: the user may manually seek out related content; for example, the user could read an article about a given topic on one site or application and then navigate to a different site or application in order to search for related keywords to find related content; or users may rely on suggestions from the site or application they are already using, for example, after reading an article, the site may recommend that the user read another similar article on the same property.

The first approach suffers from a large degree of manual labor and action that encumbers users and makes them less likely to seek out secondary sources. The second approach suffers from a focus on traversing only a single property, instead of revealing related content and context from a variety of sources.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating an example embodiment of a content delivery system, according to some example embodiments.

FIG. 3 is a flow diagram illustrating an example method for delivering related content to a user based on the user's browser history, according to some example embodiments.

FIGS. 4a, 4b, and 4c depict example user interfaces for notifying a user of recommended content based on a user's real-time internet browsing activity, according to some example embodiments.

FIG. 5 depicts an example user interface of recommended content delivered to a user based on a user's real-time internet browsing activity, according to some example embodiments.

FIG. 6 depicts an interaction diagram illustrating various example interactions between the content delivery system, VPN, network, and client device, according to some example embodiments.

FIG. 7 is a block diagram illustrating an example of a software architecture that is installed on a machine, according to some example embodiments.

FIG. 8 illustrates a diagrammatic representation of a machine in the form of a computer system within which a set of instructions, for causing the machine to perform any one or more of the methodologies discussed herein, is executed, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter are practiced without these specific details. In general, well-known instruction instances, protocols, structures, and techniques are not necessarily shown in detail.

Example embodiments provide systems and methods to deliver content to consumers based on their real-time internet activity across multiple applications. “Internet activity” encompasses forms of interaction on the internet, including clicking or pressing links, navigating through web pages, navigating or browsing between multiple applications, or loading content via the internet. More specifically, a user is provided with recommended content based on the user's observed internet activity as well as information about the user as specified within user preferences. A notification to access the recommended content is delivered to a device of the user responsive to identifying and retrieving the recommended content, while the user is browsing the Internet in real-time.

In accordance with the example embodiments, a variety of sources for data are combined to provide a user profile for the user, wherein the recommended content may be identified based on the contents of the user profile. For example, data is gathered from a user's browser history across multiple properties and is stored and catalogued within a database at a memory location associated with the user. The data may then be accessed based on a user identifier associated with the user to determine and provide recommended content to the user.

In example embodiments, a user's internet activity is observed and monitored through the interception of requests issued from applications executing on the user's device. For example, when an application hosted on the user's device sends a request to a resource on the Internet, the request is intercepted by an intermediary component (e.g. a Virtual Private Network (VPN) and/or other proxy). The intermediary component routes and splits the request to the requested resource on the Internet, and to a content delivery system. The request is assigned a unique return identifier which identifies the user's device, in order for a response from the requested resource to flow back through the intermediary component before ultimately reaching the originating application at the user's device. The intermediary component therefore monitors both the requests issued from applications on the user's device, as well as the responses from the resources to such requests.

The request routed to the content delivery system is received by the content delivery system, where the request and the return identifier are catalogued and stored within a history database at a memory location in the history database categorized by a user identifier associated with the user. Having gathered and indexed the user's requests (e.g., internet activity) within the history database, the content delivery system accesses the user activity stored in the history database to create a personalization profile for the user. In some embodiments, the personalization profile may be based on the contents of the history database as well as user preferences and settings which are explicitly defined by the user and included within a user profile associated with the user. The personalization profile may be used in conjunction with a received request to identify and retrieve recommended content which is relevant to the real-time activity and context of the user in a particular browsing session.

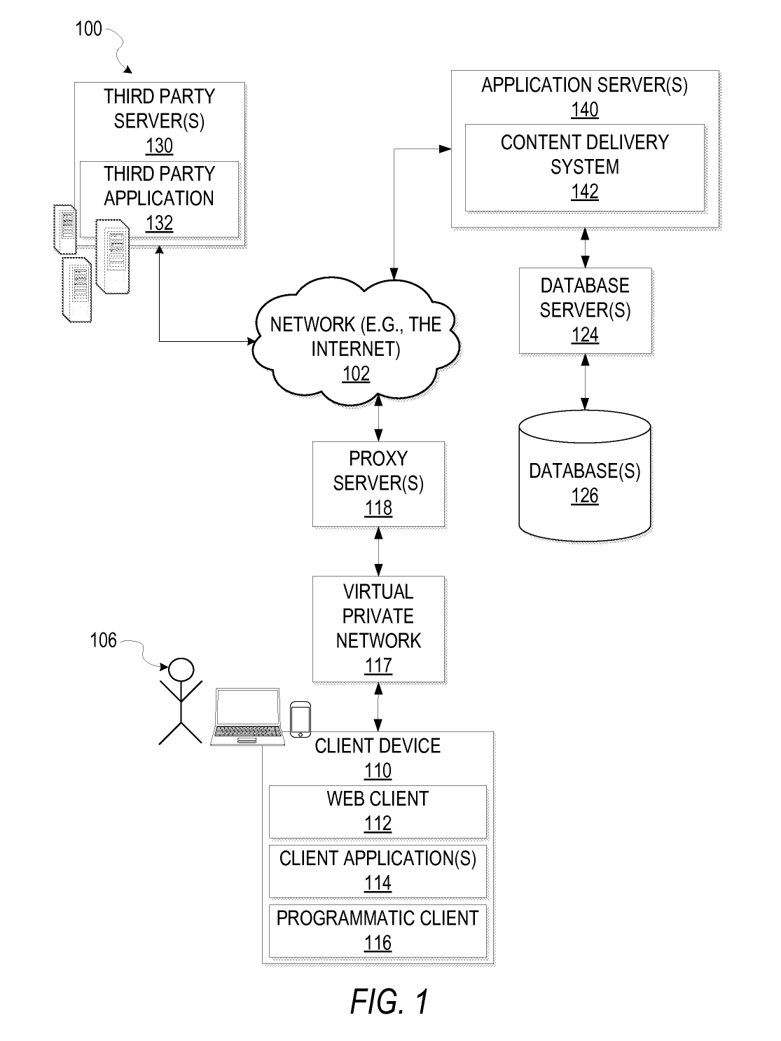

With reference to FIG. 1, an example embodiment of a high-level client-server-based network architecture 100 is shown. A network 102 provides server-side functionality to a client device 110. In some implementations, a user (e.g., user 106) interacts with the networked system 102 using the client device 110, through an intermediary component in the example form of a virtual private network (VPN) 117, and a proxy server 118. FIG. 1 illustrates, for example, a web client 112 (e.g., a browser), client application(s) 114, and a programmatic client 116 executing on the client device 110. The client device 110 may include the web client 112, the client application(s) 114, and the programmatic client 116 alone, together, or in any suitable combination. Although FIG. 1 shows one client device 110, in other implementations, the network architecture 100 comprises multiple client devices.

The client device 110 may comprise a computing device that includes at least a display and communication capabilities that provide access to the network 102. The client device 110 is a mobile smart phone. However, the client device 110 may also be, but is not limited to, a remote device, work station, computer, general purpose computer, Internet appliance, hand-held device, wireless device, portable device, wearable computer, cellular or mobile phone, Personal Digital Assistant (PDA), tablet, ultrabook, netbook, laptop, desktop, multi-processor system, microprocessor-based or programmable consumer electronic, game consoles, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 102 via a wired or wireless connection. For example, one or more portions of the network 102 comprises an ad hoc network, an intranet, an extranet, a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or any suitable combination thereof.

In some example embodiments, the client device 110 may include one or more of the applications (also referred to as “apps”) such as, but not limited to, web browsers, book reader apps (e.g., operable to read e-books), media apps (e.g., operable to present various media forms including audio and video), fitness apps, biometric monitoring apps, and messaging apps, electronic mail (email) apps.). The client application(s) 114 include various components operable to present information to the user and communicate with network 102. For example, an application is configured to locally provide the user interface and an application interface to communicate with the network 102, on an as needed basis, for data or processing capabilities not locally available (e.g., access to a database of items available for sale, to authenticate a user, to verify a method of payment). The client device 110 may also use the web browser to access mobile applications hosted on the network 102.

In various example embodiments, the user (e.g., the user 106) comprises a person, a machine, or other means of interacting with the client device 110. In some example embodiments, the user is not be part of the network architecture 100, but interacts with the network architecture 100 via the client device 110 or another means. For instance, the user provides input (e.g., touch screen input or alphanumeric input) to the client device 110 and the input is communicated to the VPN 117, which then transparently routes the input through the proxy server 118, which then communicates with the network 102. The user can interact with the networked system 102 through the VPN 117 and proxy server 118 using the client device 110. Additionally, a third party application 132, executing on a third party server 130, is shown as having programmatic access to the network 102.

Further, while the client-server-based network architecture 100 shown in FIG. 1 employs a client-server architecture, other embodiments is implemented in a distributed, or peer-to-peer, architecture system, for example. The systems of the applications server(s) 140 (e.g., the content delivery system(s) 142) may also be implemented as standalone software programs, which do not necessarily have networking capabilities.

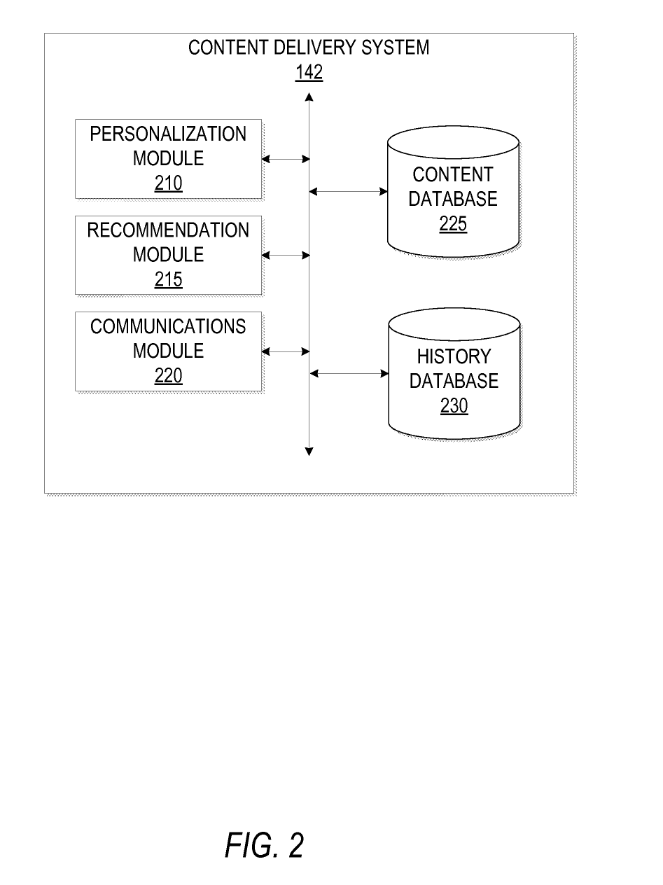

FIG. 2 is a block diagram for the content delivery system 142 that may provide functionality operable to perform various content recommendation and delivery functionality. In an example embodiment, the content delivery system 142 may include a personalization module 210, a recommendation module 215, a communications module 220, a content database 225, and a history database 230. All, or some, of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

In some example embodiments, a user's device (e.g., client device 110) transmits a request to access information on the network 102 (e.g., an article or website). The request is routed through the VPN 117, and the proxy server 118, which splits and simultaneously routes the request to the requested resource within the network 102, as well as to the content delivery system 142. The request includes a unique return identifier identifying the requesting device (e.g., client device 110). Responses to the request from the requested resource back through the proxy server 118 and the VPN 117 before reaching the client device 110.

The request and return identifier routed to the content delivery system 142 are stored and indexed within the history database 230 at a location in memory associated with a user identifier of the requesting user. In this way, the content delivery system 142 catalogues and indexes all of a user's internet activities. The content (e.g., user activity) of the history database 230 is then routed to the personalization module 210, in order to create personalization profile.

The personalization module 210 provides personalization functionality, and is operable to generate a personalization profile based on the content of the history database 230, as well as preferences explicitly expressed by the user within a user profile. Responsive to receiving an indication that a user has transmitted a request which has been indexed and stored within the history database 230, the personalization module 210 accesses user activity data within the history database 230 (e.g., based on a user identifier corresponding to the requesting user), in addition to user preferences associated with a user profile of the requesting user. The personalization module 210 uses the user activity data and expressed preferences to build a personalization profile of the user, useable by the recommendation module 215 to identify recommended content within a content database 225.

The recommendation module 215 provides recommendation functionality including identifying recommended content for a user based on a current context of a browsing session of the user (e.g., the request), and the personalization profile associated with the user, created by the personalization module 210. In some embodiments, the recommendation module 215 is configured to receive inputs including: the initial/incoming user request; the personalization profile; and content data located within the content database 225. The recommendation module 215 then ranks and sorts content retrieved from the content database 225 based on the personalization profile and the initial request. After the content from the content database 225 has been sorted, the recommendation module 215 identifies the most relevant content from the content database 225 as recommended content to deliver to the user. For example, the relevance of the content may be based on a specific context of the user's current browsing session, or may also be based on an overall context of the user's browsing and viewing behavior. The recommended content is then pushed to the communications module 220.

The communications module 220 is configured to perform various network communication functions, such as communicating with the network 102, and the database server 124. Responsive to receiving an indication that recommended content has been identified for a user, the communications module 220 transmits a notification to the device of the user indicating that relevant content has been identified. In some embodiments, the communications module 220 includes a summarization, or description of the recommended content within the notification. A user may then interact with the notification and select whether the use chooses to view the content, or to ignore the content. Responsive to receiving an indication that the user wants to view the content, the communications module 220 transmits the recommended content to the user device.

In some embodiments, the user's interaction with the notification (e.g., selecting whether or not the user would like to receive the recommended content) are transmitted to the content delivery system 142 through the VPN 117 in the same fashion as other user activities which the user performs on the user's device. Thus, the request to view or ignore the recommended content is also stored within the history database 230, and may be used by the content delivery system 142 to create a personalization profile and identify recommended content during future interactions.

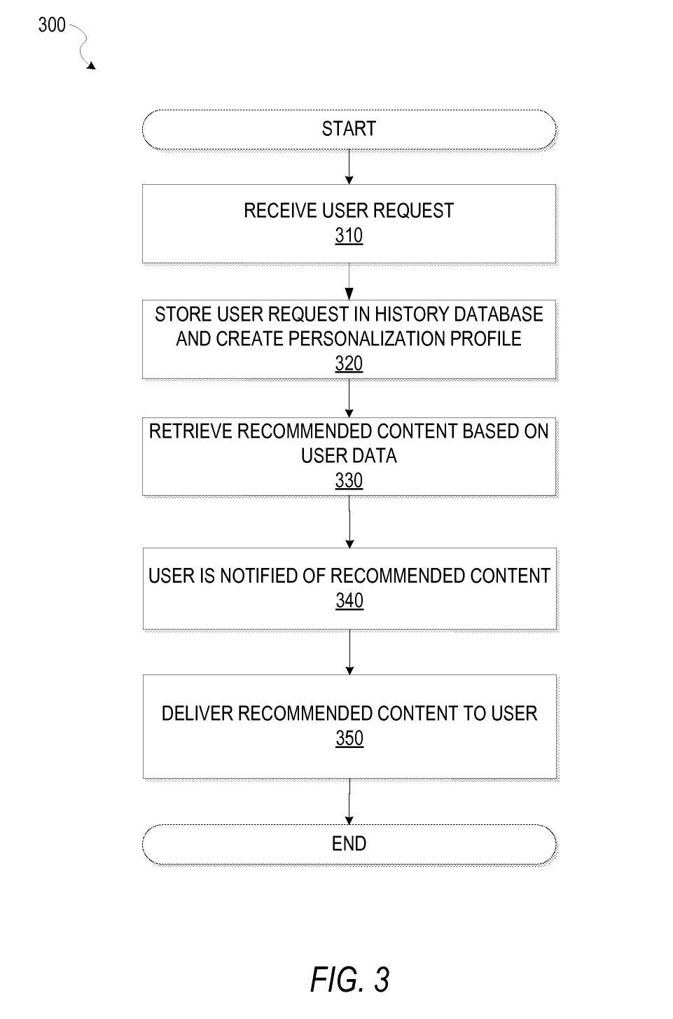

FIG. 3 is a flow diagram illustrating an example method 300 for identifying, retrieving and delivering recommended content to a user based on a personalization profile of the user and a user request. The method 300 is merely a non-limiting example of a method for delivering recommended content. At operation 310, the content delivery system 142 receives a request from a client device 110. The request may include a search query and a user identifier associated with the user. For example, the search query may include information corresponding to a particular product, media, person of interest, news article, and/or place of interest.

At operation 320, content delivery system 142 routes the request to a memory location associated with a user identifier of the user within the history database 230 which includes the historical internet activities and interactions of the user. A notification is transmitted to the personalization module 210, indicating that the user (e.g., identified by the user identifier) has transmitted a request, and that the request has been stored and indexed within the history database 230. Responsive to receiving the notification, the personalization module 210 accesses the history database 230 and retrieves user activity data, and user profile data associated with the user identifier of the user, to create a personalization profile. The personalization profile is then useable by the recommendation module 215 to identify and retrieve recommended content.

At operation 330, the user request, the personalization profile, and content from the content database 225 are routed to the recommendation module 215. The recommendation module 215 sorts and ranks the content from the content database 225 based on the user request, the personalization profile associated with the requesting user, and the content itself. Once the content form the content database 225 is sorted and ranked, the recommendation module 215 identifies and selects the most relevant content as content to recommend to the user (e.g., recommended content).

At operation 340, responsive to the recommendation module 215 identifying recommended content from within the content database 225 the communications module 220 transmits a notification to a device of the user of the recommended content. For example, the notification may indicate a particular recommended article, which the user may then select if they wish to view the article. At operation 350, the communications module 220 delivers the recommended content to the user responsive to receiving a selection of the recommended content by the user.

In some embodiments, the dismissal or acceptance of the notification received at operation 340 are also factored into the personalization profile. The communications module 220 may transmit data indicating an acceptance or a dismissal of the notification to the personalization module 210. The personalization module 210 may then store the acceptance or dismissal of the notification in the personalization profile associated with the user, in order to rank future content. For example, by collecting and storing the acceptances and the dismissals of the notifications delivered to the user, the recommendation module 215 may identify that the user accepts notifications pertaining articles written by a particular author, on a particular subject, or from a particular source more frequently than an overall average. Alternatively, the user may dismiss notifications on particular topics, sources, or authors more frequently than the overall average. This data is useable by the personalization module 210 and the recommendation module 215 to provide more accurate ranking of content, and ultimately to provide recommended content that the user is more likely to accept.

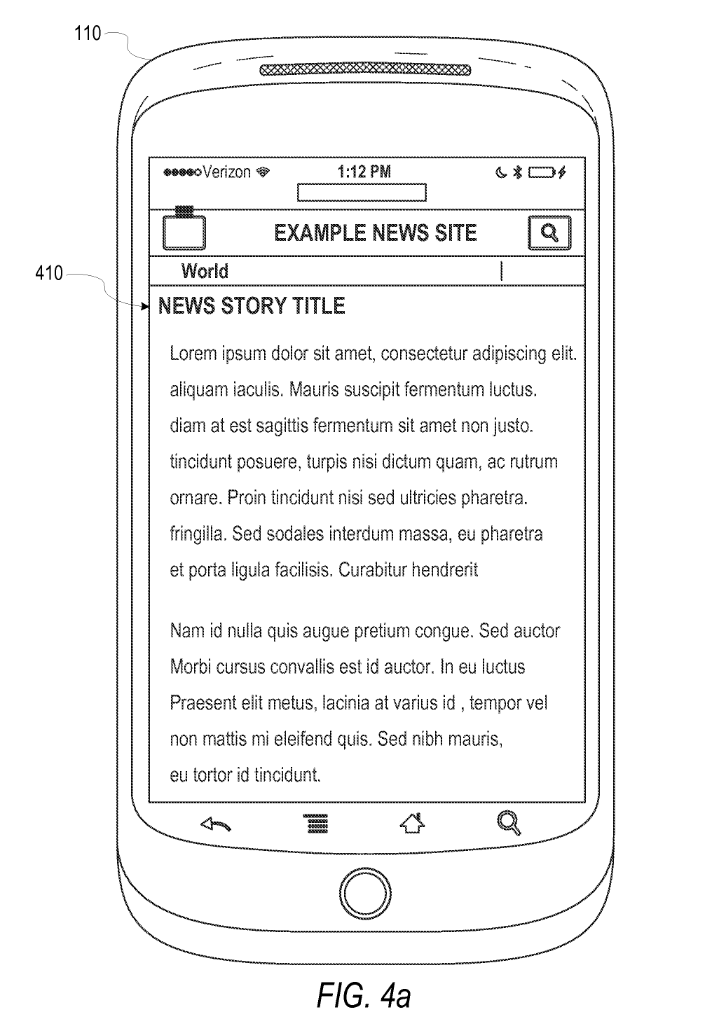

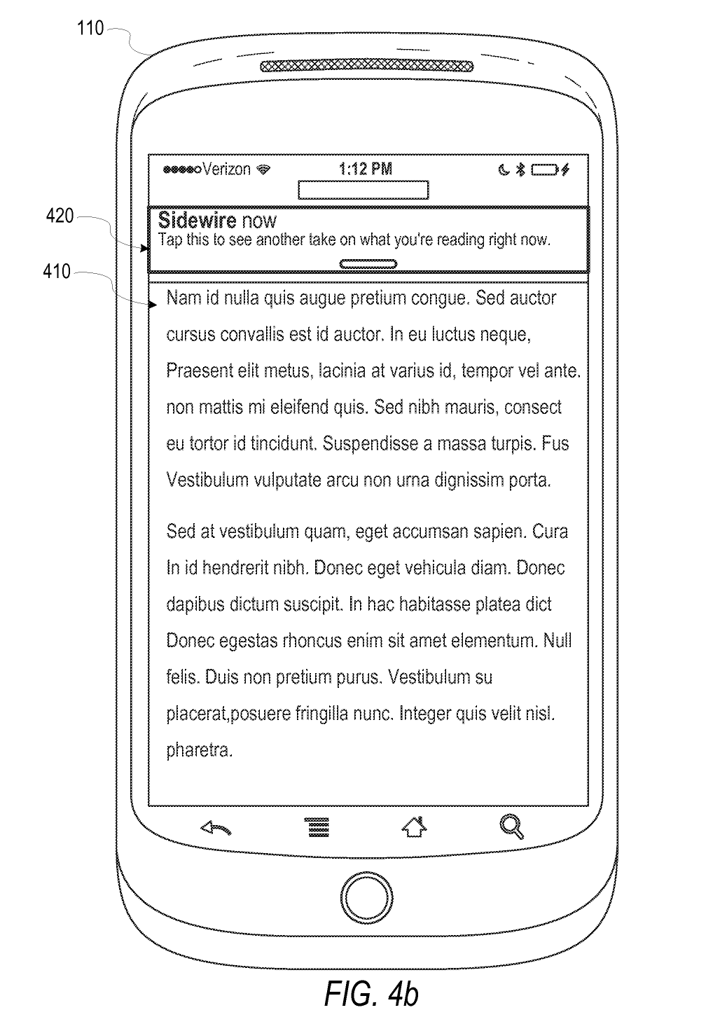

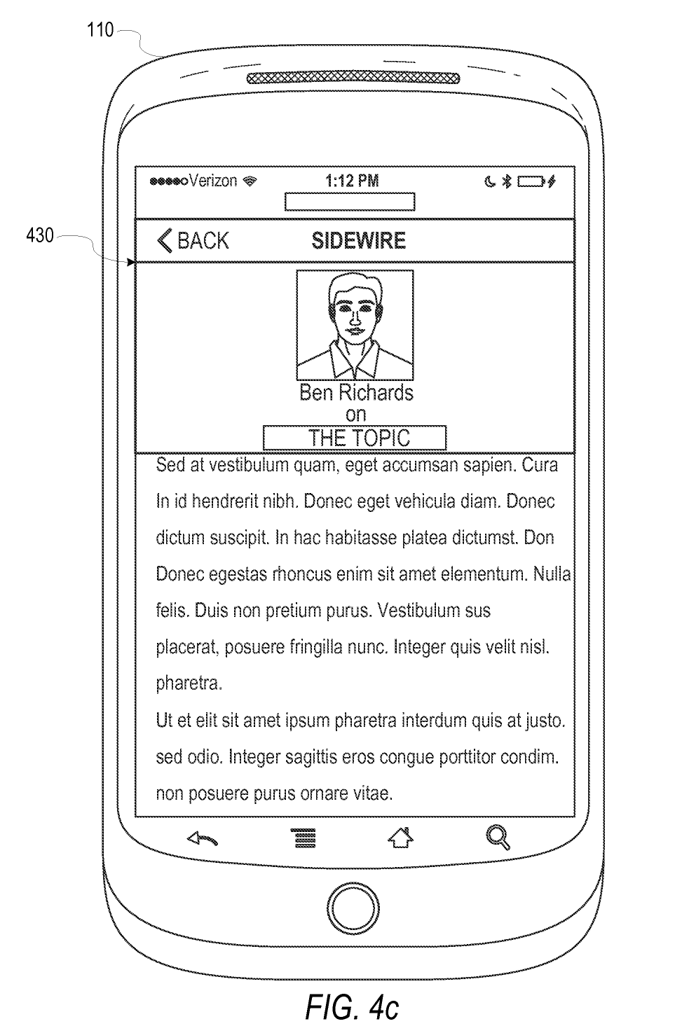

FIG. 4a depicts example user interface 410 for viewing requested content on user device 110. Interface 410 includes content which a user (e.g., user 106) has accessed on user device 110. The content includes a news article written by a particular author, on a specific subject. At the time which the user accessed the content displayed in interface 410, the request to access the content was transmitted to the content delivery system 142, and used in conjunction with a personalization profile of the user to identify and retrieve recommended content. For example, as seen in interface 410, the content may include a title (e.g., “NEWS STORY TITLE”), as well as a publishing source (e.g., “EXAMPLE NEWS SITE”).

FIG. 4b depicts a notification 420 displayed within interface 410, delivered to the user device 110 by the content delivery system 142 responsive to identifying and retrieving recommended content based on a user request and a personalization profile associated with the user. The notification 420 may include a message indicating that recommended content has been identified, and may also be configured to receive an input from the user (e.g., swipe, click, tap, etc.) to view or ignore the recommended content. For example, the user may “swipe down” on the notification to access the recommended content, or alternatively, may “swipe up” to ignore the notification. The notification includes an email, text message, or desktop notification. The notification may include a brief description of the recommended content, such as an indication of the author, title, publisher, and summarization. In some embodiments, the notification may also include an indication of a topic-overlap of the requested content displayed in user interface 410, and the recommended content referenced in the notification 420. The topic-overlap may include, for example, indications that the recommended content is similar to the requested content based on being written by the same author, being on a similar topic, being from the same source, or being published on or around the same date and time.

FIG. 4c depicts an interface 430 of recommended content presented by the content delivery system 142, to the requesting user in real-time, responsive to the user interacting with the notification 420. In some embodiments, the interface 430 includes a representation of an author of the content (e.g., “Ben Richards”), and a title of the content (e.g., “The Topic”). The recommended content may include news, advertisements, and informational content related to a requested resource which the user may have previously viewed (e.g., as seen in FIG. 4a), as well as a user's context (e.g., their real-time browsing session).

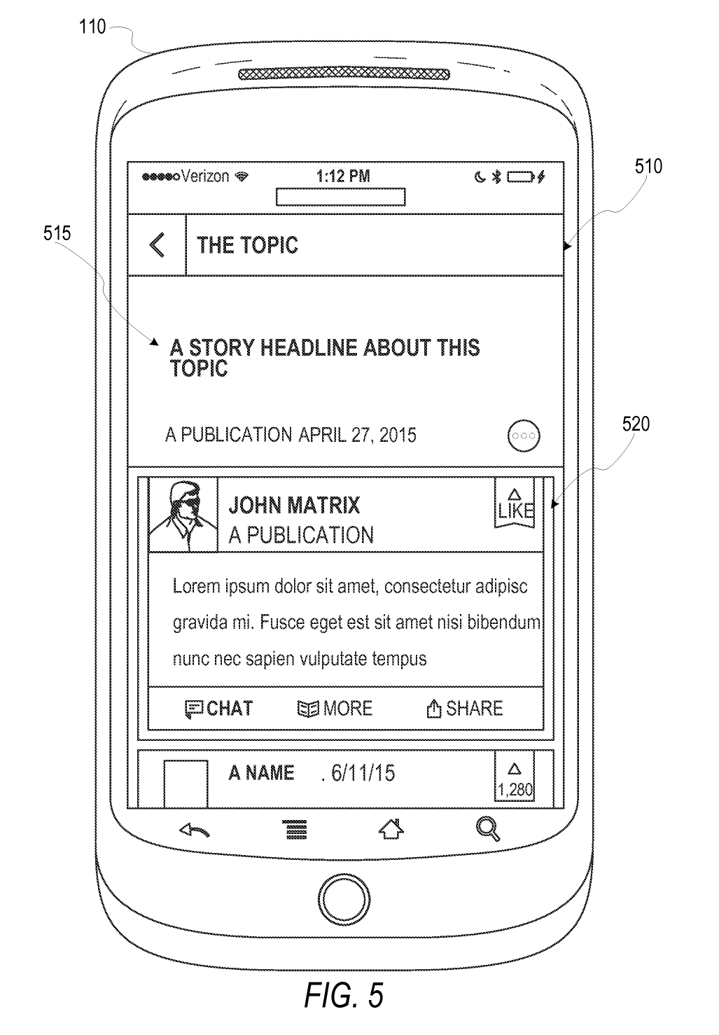

FIG. 5 depicts a recommended content interface 510, delivered to a client device 110 based on a user's real-time internet browsing activity, which includes recommended content 515, and related content 520. The related content 520 may include commentary about the recommended content 515 from authors and contributors which the content delivery system 142 has identified as relevant to the user of the requesting device (e.g., user 106). For example, responsive to a user providing an indication to view the recommended content (e.g., based on an interaction with the notification 420), the content delivery system 142 causes display of the recommended content 515 within the recommended content interface 510. The recommended content interface 510 is shown to include additional, related content 520, which includes additional commentary (e.g., published by the content delivery system 142). In some embodiments, the related content 520 includes relevant postings published on social media websites and applications (e.g., FACEBOOK, TWITTER, INSTAGRAM).

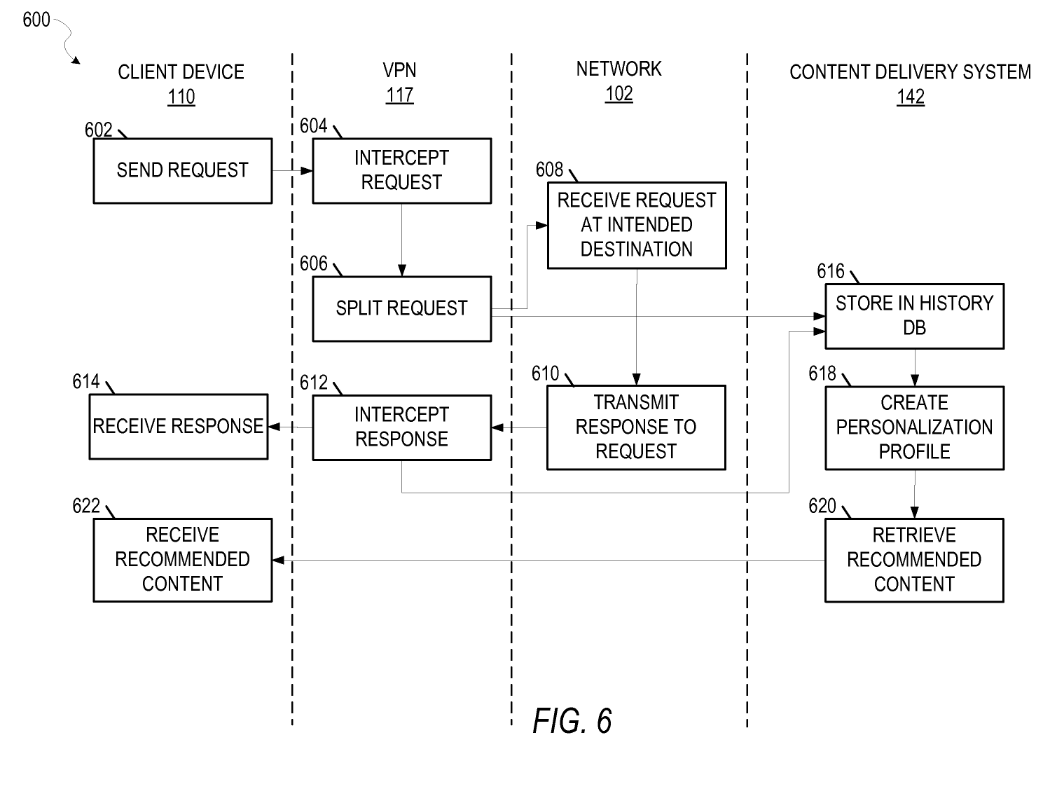

FIG. 6 is an interaction diagram 600 depicting example exchanges between a client device (e.g., client device 110), a VPN (e.g., VPN 117), a network (e.g., network 102), and the content delivery system 142. As shown, at operation 602, a user of client device 110 transmits a request to access content existing on a network (e.g., network 102). At operation 604, the request is intercepted by the VPN 117, and at operation 606, is split and routed to two distinct destinations: the requested resource at the network 102, and a database (e.g., the history database 230) of the content delivery system 142.

At operation 608, the request is received at the network 102, where it is ultimately transmitted to the requested resource, along with an identifier associated with the requesting device (e.g., client device 110). At operation 610, the requesting resource may respond to the request and transmit a response back to the client device 110. At operation 612, the response to the request is intercepted by the VPN 117 before ultimately being delivered to the client device 110 at operation 614.

At operation 616, the content delivery system 142 receives the split request from the VPN 117 and stores the split request within the history database 230 at a location in memory associated with a user identifier of the requesting user. The content delivery system 142 may additionally store relevant data to the request, such as a time and date of the request, as well as an identifier of the client device 110. At operation 618, the content delivery system 142 updates a personalized profile associated with the user identifier of the user. At operations 620, the content delivery system 142 retrieves recommended content based on at least the personalized profile and user data within the history database 230. At operations 622, the content delivery system 142 transmits the recommended content (or a notification to access the recommended content) to the client device 110.

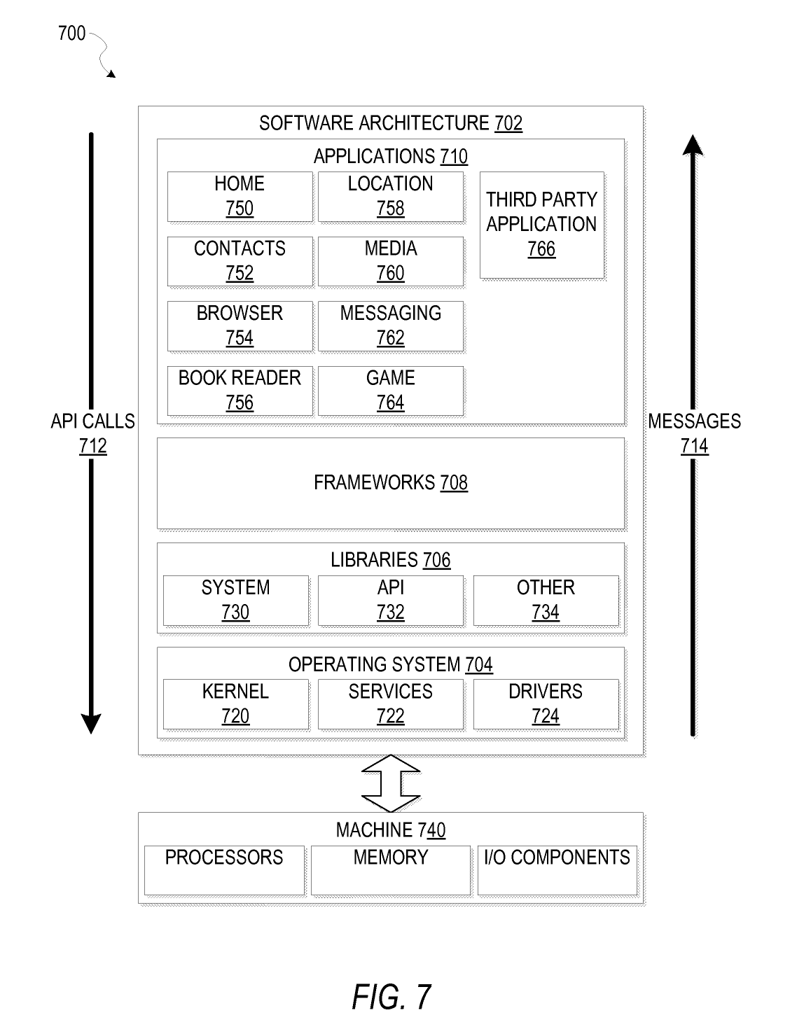

FIG. 7 is a block diagram 700 illustrating an architecture of software 702, which may be installed on any one or more of client devices 110 described above. FIG. 7 is merely a non-limiting example of a software architecture, and it will be appreciated that many other architectures may be implemented to facilitate the functionality described herein. The software 702 may be executing on hardware such as machine 740 that includes processors, memory, and I/O components. In the example architecture of FIG. 7, the software 702 is conceptualized as a stack of layers where each layer may provide particular functionality. For example, the software 702 may include layers such as an operating system 704, libraries 706, frameworks 708, and applications 710. Operationally, the applications 710 may invoke application programming interface (API) calls 712 through the software stack and receive messages 714 in response to the API calls 712.

The operating system 704 may manage hardware resources and provide common services. The operating system 704 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 are responsible for controlling or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 706 may provide a low-level common infrastructure that may be utilized by the applications 710. The libraries 706 may include system 730 libraries (e.g., C standard library) that may provide functions such as memory allocation functions, string manipulation functions, mathematic functions, and the like. In addition, the libraries 706 may include API libraries 732 such as media libraries (e.g., libraries to support presentation and manipulation of various media formats such as MPREG4, H.264, MP3, AAC, AMR, JPG, PNG), graphics libraries (e.g., an OpenGL framework that is used to render 2D and 3D in a graphic content on a display), database libraries (e.g., SQLite that may provide various relational database functions), web libraries (e.g., WebKit that may provide web browsing functionality), and the like. The libraries 706 may also include a wide variety of other libraries 734 to provide many other APIs to the applications 710.

The frameworks 708 may provide a high-level common infrastructure that is utilized by the applications 710. For example, the frameworks 708 may provide various graphic user interface (GUI) functions, high-level resource management, high-level location services, and so forth. The frameworks 708 may provide a broad spectrum of other APIs that is utilized by the applications 710, some of which is specific to a particular operating system or platform.

The applications 710 include a home application 750, a contacts application 752, a browser application 754, a book reader application 756, a location application 758, a media application 760, a messaging application 762, a game application 764, and a broad assortment of other applications such as third party application 766. In a specific example, the third party application 766 (e.g., an application developed using the Android™ or iOS™ software development kit (SDK) by an entity other than the vendor of the particular platform) is mobile software running on a mobile operating system such as iOS™, Android™, Windows® Phone, or other mobile operating systems. In this example, the third party application 766 may invoke the API calls 712 provided by the mobile operating system 704 to facilitate functionality described herein.

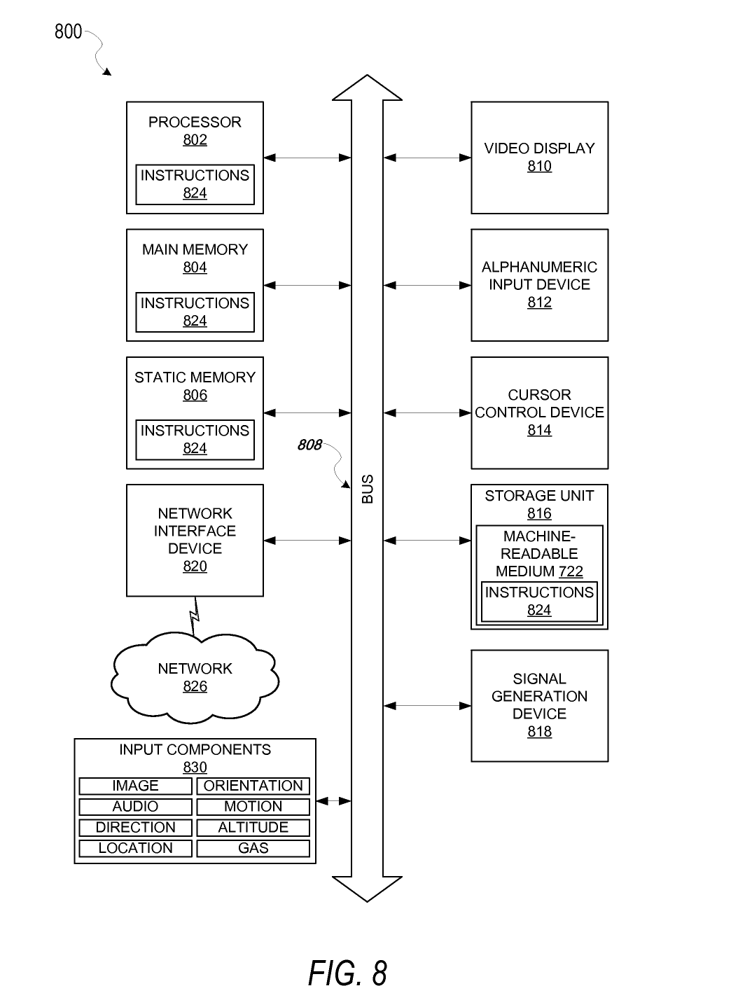

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 824 (e.g., software, a program, an application, an applet, an app, or other executable code) for causing the machine 800 to perform any one or more of the methodologies discussed herein may be executed. In alternative embodiments, the machine 800 operates as a standalone device or is connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include a collection of machines 800 that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the static memory 806, within the processor 802 (e.g., within the processor's cache memory), or both, during execution thereof by the machine 800. Accordingly, the main memory 804, static memory 806 and the processor 802 is considered as machine-readable media 822. The instructions 824 are transmitted or received over a network 826 via the network interface device 820.

In some example embodiments, the machine 800 is a portable computing device, such as a smart phone or tablet computer, and have one or more additional input components 830 (e.g., sensors or gauges). Examples of such input components 830 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components is accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., instruction 824) for execution by a machine (e.g., machine 800), such that the instructions, when executed by one or more processors of the machine 800 (e.g., processor 802), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 822 is non-transitory in that it does not embody a propagating signal. However, labeling the machine-readable medium 822 as “non-transitory” should not be construed to mean that the medium is incapable of movement; the medium should be considered as being transportable from one physical location to another. Additionally, since the machine-readable medium 822 is tangible, the medium may be considered to be a machine-readable device.

The instructions 824 may further be transmitted or received over a communications network 826 using a transmission medium via the network interface device 820 and utilizing any one of a number of well-known transfer protocols (e.g., hypertext transfer protocol (HTTP)). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 802, for example, to constitute a particular hardware module at one instance of time and to constitute a different hardware module at a different instance of time.

Hardware modules can provide information to, and receive information from, other hardware modules. Accordingly, the described hardware modules are regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via the network 826 (e.g., the Internet) and via one or more appropriate interfaces (e.g., an application program interface (API)).

The performance of certain of the operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method to deliver content to a user device, the method comprising:
recording network-related activity of the user device;
generating a personalization profile based on the network-related activity;
identifying recommended content, based on the network-related activity and the personalization profile; and
presenting the recommended content on the user device.

2. The method of claim 1, wherein the network-related activity includes requests issued from applications executing on the user device, and the recording comprises:
intercepting the requests by an intermediary component; and
recording the requests within a user profile.

3. The method of claim 2, wherein the intermediary component is communicatively coupled in a request/response path between a user device and a network

4. The method of claim 1, wherein the network-related activity comprises interaction related to resources accessible via the Internet, the network-related activity comprising at least one of clicking links, navigating through webpages, navigating through applications, and loading content.

5. The method of claim 1, wherein the presenting of the recommended content on the user device includes:
presenting an interactive notification; and
receiving a response to the interactive notification to view the recommended content.

6. The method of claim 5, wherein the interactive notification is presented in real-time, during a current browsing session.

7. The method of claim 1, wherein the recommended content includes informational content that is additive to user context of the network -related activity; and wherein the informational content includes news, advertisements, commentary, or social media activity.

8. A non-transitory machine-readable storage medium comprising instructions that, when executed by one or more processors of a machine, cause the machine to perform operations comprising:
recording network-related activity of the user device;
generating a personalization profile based on the network-related activity;
identifying recommended content, based on the network -related activity; and
presenting the recommended content on the user device.

9. The non-transitory machine-readable storage medium of claim 8, wherein the network related activity includes requests issued from applications executing on the user device, and the recording comprises:
intercepting the requests by an intermediary component; and
recording the requests within a user profile.

10. The non-transitory machine-readable storage medium of claim 9, wherein the intermediary component is communicatively coupled in a request/response path between a user device and a network

11. The non-transitory machine-readable storage medium of claim 8, wherein the network-related activity comprises interaction related to resources accessible via the Internet, the network-related activity comprising at least one of clicking links, navigating through webpages, navigating through applications, and loading content.

12. The non-transitory machine-readable storage medium of claim 8, wherein the presenting of the recommended content on the user device includes:
presenting an interactive notification; and
receiving a response to the interactive notification to view the recommended content.

13. The non-transitory machine-readable storage medium of claim 8, wherein the interactive notification is presented in real-time, during a current browsing session.

14. The non-transitory machine-readable storage medium of claim 8, wherein the recommended content includes informational content which is additive to user context of the network-related activity; and wherein the informational content includes news, advertisements, commentary, and social media activity.

15. A system comprising:
an intermediary component to intercept and record network-related activity of a user device within a history database;
a personalization module to generate a personalization profile based on the network-related activity within the history database;
a recommendation module to identify recommended content, based on the network-related activity and the personalization profile; and
a communications module to present the recommended content on the user device.

16. The system of claim 15, wherein the network-related activity includes requests issued from applications executing on the user device.

17. The system of claim 15, wherein the intermediary component is communicatively coupled in a request/response path between a user device and a network.

18. The system of claim 15, wherein the network-related activity comprises interaction related to resources accessible via the Internet, the network-related activity comprising at least one of clicking links, navigating through webpages, navigating through applications, and loading content.

19. The system of claim 15, wherein the presenting of the recommended content on the user device includes:
presenting, via the communications module, an interactive notification; and
receiving a response to the interactive notification to view the recommended content.

20. The system of claim 15, wherein the interactive notification is presented in real-time at the user device, during a current browsing session.
